(19) United States
(12) Patent Application Publication
(10) Pub. No.: US 2026/0179029 A1
(43) Pub. Date: Jun. 25, 2026

(54) System and Method for Decentralized E-commerce Fulfillment Using Personal Spaces

(71) Applicant: Abdul A Muhammed, Dallas, TX (US)

(72) Inventor: Abdul A Muhammed, Dallas, TX (US)

(21) Appl. No.: 18/991,412

(22) Filed: Dec. 21, 2024

(51) Int. Cl. G06Q 10/0833; G06Q 10/0832; G06Q 10/087

(52) U.S. Cl. CPC G06Q 10/0833; G06Q 10/0832; G06Q 10/087

(57) ABSTRACT

This invention relates to a system and method for transforming personal spaces into operational e-commerce fulfillment hubs. The system comprises a software platform that integrates inventory management, order processing, and shipping logistics, designed for home-based fulfillment operations. The platform's unique architecture allows seamless integration with home environments and scalable logistics operations, enabling users to efficiently manage and process e-commerce orders from their own spaces using minimal external resources.

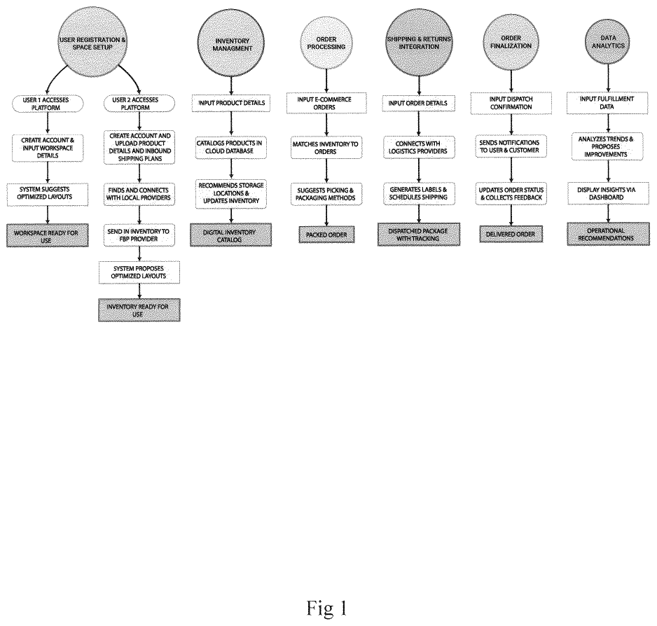

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF INVENTION

The present invention pertains to the field of e-commerce fulfillment services, specifically targeting individuals who wish to utilize their private spaces for business purposes.

### BACKGROUND OF INVENTION

The e-commerce industry has experienced exponential growth in recent years, particularly accelerated by global events such as the COVID-19 pandemic. This surge in online shopping has led to increased pressure on traditional fulfillment models, exposing limitations and inefficiencies in existing systems.

As consumer expectations for faster delivery times and more flexible shopping options continue to rise, there is a pressing need for innovative solutions in e-commerce fulfillment. Historically, e-commerce fulfillment has been dominated by large, centralized warehouses operated by major retailers and third-party logistics providers. While this model has been effective for handling large volumes of orders, it often struggles with the demands of modern e-commerce, such as:
1. Rapid Order Processing: The need for same-day or next-day delivery has put immense pressure on fulfillment centers to process orders more quickly.
2. Inventory Management: Mismanaged inventories can lead to stockouts, overselling, and customer dissatisfaction.
3. Last-Mile Delivery: The final leg of delivery remains one of the most challenging and costly aspects of e-commerce fulfillment.
4. Space Utilization: As order volumes increase, many fulfillment centers struggle with limited space and the need for more efficient storage solutions.
5. Flexibility: Traditional fulfillment models often lack the agility to adapt to fluctuating demand and changing consumer preferences

Several patents have attempted to address these challenges in recent years:
1. U.S. Pat. No. 7,251,621B1 (2006) introduced a method for home delivery of local retail e-commerce orders, aiming to improve last-mile delivery efficiency.
2. GB Patent 2533846A (2015) proposed a system for fulfilling e-commerce orders from a hierarchy of fulfillment centers, combining large and small centers to optimize order processing.
3. U.S. Pat. No. 9,928,474,B1 (2018) presented a method for automated picking of items for order fulfillment using robotic systems, addressing the need for faster order processing.
4. U.S. Pat. No. 10,657,486B1 (2020) introduced a system for dynamic inventory allocation across multiple fulfillment centers to improve inventory management and reduce stockouts.

Despite these innovations, there remains a significant gap in the market for solutions that can effectively transform personal spaces into operational fulfillment hubs. This gap is particularly evident in urban areas where traditional warehousing space is limited and expensive, and where consumers increasingly expect rapid, local delivery options. The rise of the gig economy and the increasing desire for flexible work arrangements have created a pool of potential operators for home-based fulfillment centers. However, existing systems are not designed to support individuals in efficiently managing inventory, processing orders, and coordinating shipping from their personal spaces. Furthermore, current solutions often fail to address the unique challenges of home-based fulfillment, such as:
Limited storage space and the need for efficient organization of diverse product types
Integration with multiple e-commerce platforms and marketplaces
Compliance with local zoning laws and regulations for home-based businesses
Balancing personal living space with business operations
Scaling operations to meet fluctuating demand without significant capital investment

The present invention seeks to address these unmet needs by providing a comprehensive system and method for transforming personal spaces into efficient, scalable e-commerce fulfillment hubs. By leveraging advanced software algorithms, IoT technologies, and innovative space utilization techniques, this invention aims to democratize e-commerce fulfillment and create new opportunities for individuals to participate in the growing digital economy.

### SUMMARY OF INVENTION

The Fulfillment by People invention involves a unique process where individuals can turn their homes or private spaces into hubs for fulfilling e-commerce orders. This process includes:
1. Inventory management software integrated with personal space layout.
2. Order processing technology allowing users to track and manage orders seamlessly.
3. Shipping integration for direct dispatch from home to customers.
4. A fulfillment platform that connects users to third-party logistics companies and partners, ensuring scalable operations.
5. A data analytics system to optimize fulfillment performance and space usage.

### Comparison with Existing Patents

Unlike U.S. Pat. No. 7,251,621B1, which focuses solely on last-mile delivery, this invention offers a holistic solution encompassing inventory management, order processing, and logistics.
While GB Patent 2533846A optimizes fulfillment across large and small centers, this system uniquely empowers individuals to operate decentralized hubs.

### Advantages for Gig Economy Workers

Flexible income opportunities by leveraging personal spaces.
Minimal upfront investment compared to traditional fulfillment operations.
Access to training resources and performance analytics to enhance productivity.

### Zoning Laws

The system includes a compliance checker tool that:
Provides guidelines for operating home-based businesses in different jurisdictions.
Alerts users to potential zoning conflicts based on their location.
Offers resources to apply for necessary permits or licenses.

### Privacy and Data Security

Key measures include:
End-to-end encryption for data transfer.
Role-based access controls to limit user permissions.
Regular security audits to identify and address vulnerabilities.

### Economic and Environmental Impact

### Economic Benefits

Reduces dependency on expensive warehouse facilities.
Lowers operational costs for small business owners.
Generates new income streams for individuals with underutilized spaces.

### Sustainability

Encourages local fulfillment, reducing transportation-related emissions.
Promotes efficient space utilization, minimizing the need for additional infrastructure.
Reduces packaging waste by optimizing order handling and shipment sizes.

### Provider Matching and Selection System

The system includes a centralized marketplace that enables brands to connect with fulfillment providers using advanced matching algorithms. Key features include:
Search and Filter Options: Brands can search for providers based on proximity, storage capacity, ratings, and pricing.
Provider Profiles: Detailed provider profiles display storage availability, pricing structures, service details, photos, reviews, and ratings.
Interactive Map Integration: A real-time map shows the location and details of nearby providers, helping brands make informed decisions.
Automated Matching Algorithm: The platform uses input criteria (inventory size, weight, shipping origin) to rank suggested providers by cost-effectiveness, proximity, and reliability.

### DETAILED DESCRIPTION

Software Architecture Overview

The software platform is designed to be lightweight and easy to use, operating across a range of personal devices such as smartphones, tablets, and computers. It features a cloud-based backend, allowing users to synchronize data across multiple devices and enabling remote monitoring and control. The platform includes modules for inventory management, order processing, packaging optimization, and shipping integration. Users can easily navigate through these modules from a user-friendly dashboard.

### Dashboards for Brands and Providers

Brand Dashboard: Offers a comprehensive view of active providers, inventory status, order tracking, and cost breakdowns. It includes analytics tools to assess fulfillment performance and operational expenses.
Provider Dashboard: Designed for fulfillment operators, this dashboard allows real-time inventory management, shipment tracking, earnings monitoring, and live notifications for orders or issues.

Software Workflow and Screen Steps
1. User Registration and Space Setup:
User 1 (Service Provider) accesses the platform.
Creates account and inputs workspace details.
System suggests optimized layouts.
Workspace is prepared for use.
2. User 2 (Brands) accesses the platform:
Creates account and uploads product details and inbound shipping plans.
Finds and connects with local providers, viewing service details, location, capacity, pricing, and ratings on an interactive map.
Sends inventory to FBP Provider.
System suggests optimized layouts.
3. Inventory Management:
User inputs product details.
System catalogs products in a cloud database.
Suggests storage locations and updates inventory in real-time.
Generates a digital inventory catalog.

### 4. Order Processing:

System receives e-commerce orders.
Matches inventory to orders.
Suggests picking and packaging methods.
Produces a packed order ready for shipping.

### Order Fulfillment Workflow

The system provides a guided workflow for picking, packing, and shipping:
Interactive Checklists: A dynamic checklist ensures accurate fulfillment by guiding providers through each step of the process.
Progress Tracking: Users can monitor real-time progress for each order from picking to shipping.
Integration with E-commerce Platforms: Order details and shipping labels can be imported directly from integrated platforms, reducing manual input.
5. Shipping & Returns Integration:
System processes order details.
Connects with logistics providers.
Generates shipping labels, receives and schedules shipping.
Outputs a dispatched package with tracking information.
6. Order Finalization:
System receives dispatch confirmation.
Sends notifications to user and customer.
Updates order status and collects feedback.
Confirms delivered order.
7. Data Analytics:
System inputs fulfillment data.
Analyzes trends and suggests improvements.
Displays insights via dashboard.
Provides operational recommendations.

1. A computer-implemented method for configuring a personal space operated by an independent fulfillment provider as an e-commerce fulfillment hub, comprising: receiving, via a computing device, a digital spatial layout of the personal space including dimensions and available storage regions; executing an optimization algorithm to generate an arrangement of storage locations within the personal space based on the spatial layout; mapping, by the system, item identifiers to corresponding storage locations and storing the mapping in a cloud-based inventory database; ingesting, via one or more e-commerce application programming interfaces (APIs), electronic order data associated with a merchant seller account; generating, by the system, a guided pick-and-pack workflow comprising step-by-step instructions specific to the generated arrangement of storage locations; integrating, by the system, with logistics provider APIs to automatically generate shipping labels and schedule shipment pickup; updating, in real time, inventory levels and order status based on completion of workflow steps.

2. A software platform that enables users to manage inventory, process orders, and handle shipping logistics from their homes.

3. The method of claim 1, further comprising a customer support system integrated with the fulfillment platform to assist with troubleshooting and optimization of home-based fulfillment operations.

4. The method of claim 1, further comprising the ability to connect to third-party logistics providers for scalable shipping solutions from personal spaces.

5. The method of claim 1, further comprising data analytics integrated into the platform for monitoring fulfillment operations and improving space usage and order processing.

6. A software platform integrated with personal space management tools, comprising: a cloud-based backend; a mobile application; a user dashboard for real-time order tracking, inventory management, and shipping logistics.

7. The system of claim 6, wherein users can upload their home space layout and inventory list to the platform, which then generates optimized packing and shipping workflows based on the user's available space and the product being processed.

8. The system of claim 6, wherein the platform includes real-time notifications and alerts for users to track order statuses, inventory needs, and shipment confirmations, ensuring seamless operations at all stages.
